(19) United States
(12) Patent Application Publication
(10) Pub. No.: US 2024/0397415 A1
(43) Pub. Date: Nov. 28, 2024

(54) A method for defining neighbor relations in a communication network

(71) Applicant: Elisa Oyj, Helsinki (FI)

(72) Inventors: Riku ERTIMO, Helsinki (FI); Antero KOLEHMAINEN, Helsinki (FI)

(21) Appl. No.: 18/695,977

(22) PCT Filed: Oct. 7, 2022
(86) PCT No.: PCT/FI2022/050667

§ 371 Date: Mar. 27, 2024

(30) Foreign Application Priority Data
Oct. 12, 2021 (FI) 20216055

(51) Int. Cl. H04W 48/16

(52) U.S. Cl. CPC H04W 48/16

(57) ABSTRACT

A computer implemented method for defining neighbor relations in a communication network (110). The method comprises receiving (610) neighbor cell measurement data from a mobile user equipment, wherein said neighbor cell is of another radio access technology compared to the radio access technology of the current cell serving said mobile user equipment, comparing (620) the received measurement data with a threshold, and storing (630) a relational object connecting said serving cell and said neighbor cell based on said comparison.

### TECHNICAL FIELD

The present disclosure generally relates to the performance of communication networks. The disclosure relates particularly, though not exclusively, to a method for defining neighbor relations in a communication network.

### BACKGROUND

This section illustrates useful background information without admission of any technique described herein representative of the state of the art.

Cellular communication networks are complex systems comprising a plurality of cells serving users of the network. In order for a communication network to operate as intended and to provide a planned quality of service, cells of the communication network need to operate as planned.

The development of cellular network has occurred by means of providing further network generations. Currently, the cellular networks have evolved from the first generation (1G) mobile networks to fourth generation (4G) and fifth generation (5G) mobile networks over the years. In each generation the network performance as measured by throughput has been increased.

As new network generations are evolved, there are occasions in which the developed technology relies on prior technology. In particular, current 5G technology provides for a non-standalone mode in which a mobile user has first to be connected to a 4G cell before it can use services of a 5G cell. Now a new approach for coping with such a situation is provided.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect of the present invention, there is provided a computer implemented method for defining neighbor relations in a communication network, the method comprising:
receiving neighbor cell measurement data from a mobile user equipment, wherein said neighbor cell is of another radio access technology compared to the radio access technology of the current cell serving said mobile user equipment;
comparing the received measurement data with a threshold; and
storing a relational object connecting said serving cell and said neighbor cell based on said comparison.

In certain embodiments, said measurement data indicates power of a signal received from the neighbor cell.

In certain embodiments, said relational object is stored in the event the power exceeds the threshold.

In certain embodiments, the serving cell is a cell of the fourth generation mobile network, LTE cell, and the neighbor cell is a cell of the fifth generation mobile network, NR cell.

In certain embodiments, said receiving neighbor cell measurement data comprises receiving measurement data regarding inter-radio access technology, inter-RAT, handover.

In certain embodiments, said receiving neighbor cell measurement data comprises receiving an event B1 measurement report.

In certain embodiments, said storing a relational object comprises storing an identifier of the neighbor cell (into data or control data of the serving cell maintained within the communication network).

In certain embodiments, the method comprises storing the relational object into a network element or into a memory accessible by the network element. In certain embodiments, said network element is a network element that controls inter-RAT handovers of mobile user equipments in said communication network.

According to a second example aspect of the present invention, there is provided an apparatus, comprising:
a processor; and
a memory including computer program code, the memory and the computer program code being configured, with the processor, to cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of the first aspect or any related embodiment.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a scenario according to an example embodiment;

FIG. 2 shows a block diagram of an apparatus according to an example embodiment;

FIGS. 3-5 schematically show defining of neighbor relations in a communication network in certain embodiments;

FIG. 6 shows a flow chart according to an example embodiment;

FIG. 7 illustrates an event B1 measurement according to an example embodiment;

FIG. 8 shows a flow chart according to another example embodiment; and

FIG. 9 shows an effect of an implemented plan according to an example embodiment.

### DETAILED DESCRIPTION

In the following description, like reference signs denote like elements or steps.

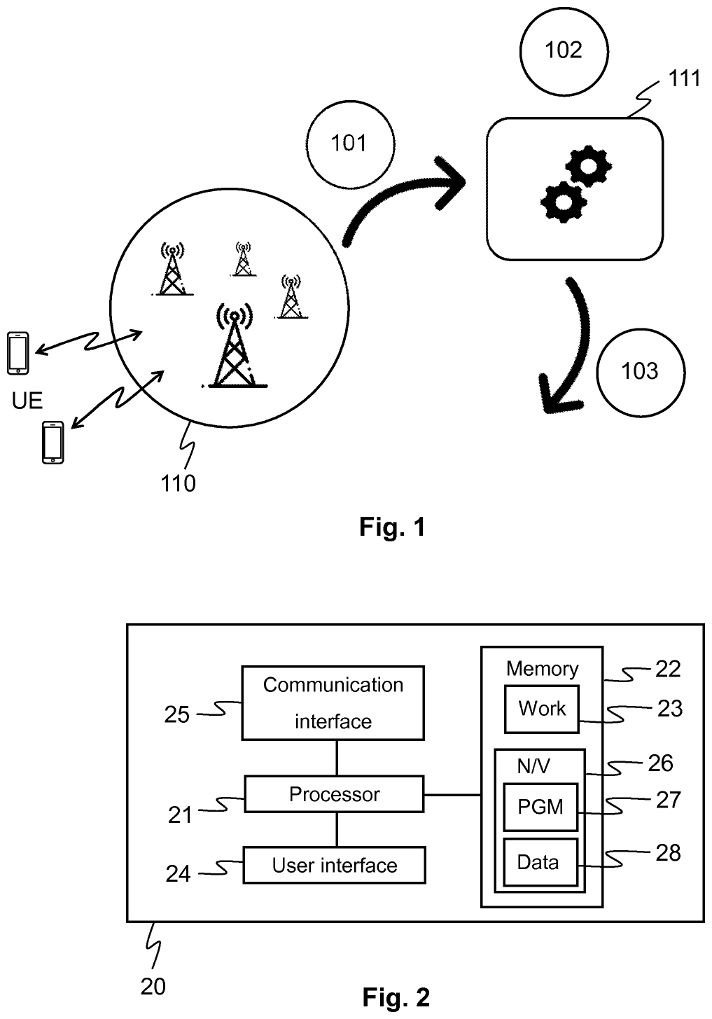

FIG. 1 shows an example scenario according to an embodiment. The scenario shows a communication network 110 serving a plurality of user devices UE (user equipment, UE) and comprising a plurality of cells and base station sites and other network devices, and an automated system 111 configured to implement neighbor relations definition operations of the communication network 110.

In an embodiment, the scenario of FIG. 1 operates as follows: In phase 101, the automated system 111 obtains neighbor cell measurement data from mobile user equipment(s) UE, wherein said neighbor cell is of another radio access technology (RAT) compared to the radio access technology of the current cell serving said mobile user equipment(s) UE.

In phase 102, the automated system 111 compares the received measurement data with a threshold.

In phase 103, the automated system stores a relational object to connect said serving cell and said neighbor cell if the measurement data exceeds the threshold. The connection thus established between the cells is implemented in the network 110 to improve the performance of the network.

FIG. 2 shows a block diagram of an apparatus 20 according to an embodiment. The apparatus 20 is for example a general-purpose computer or server or some other electronic data processing apparatus. The apparatus 20 can be used for implementing at least some embodiments of the invention. That is, with suitable configuration the apparatus 20 is suited for operating for example as the automated system 111.

The apparatus 20 comprises a communication interface 25, a processor 21, a user interface 24, and a memory 22.

The communication interface 25 comprises in an embodiment a wired and/or wireless communication circuitry, such as Ethernet, Wireless LAN, Bluetooth, GSM, CDMA, WCDMA, LTE, and/or 5G circuitry. The communication interface can be integrated in the apparatus 20 or provided as a part of an adapter, card or the like, that is attachable to the apparatus 20. The communication interface 25 may support one or more different communication technologies. The apparatus 20 may also or alternatively comprise more than one communication interface 25.

The processor 21 may be a central processing unit (CPU), a microprocessor, a digital signal processor (DSP), a graphics processing unit, an application specific integrated circuit (ASIC), a field programmable gate array, a microcontroller or a combination of such elements.

The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 comprises a work memory 23 and a persistent (non-volatile, N/V) memory 26 configured to store computer program code 27 and data 28. The memory 26 may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like.

The apparatus 20 may comprise a plurality of memories 26. The memory 26 may be constructed as a part of the apparatus 20 or as an attachment to be inserted into a slot, port, or the like of the apparatus 20 by a user or by another person or by a robot. The memory 26 may serve the sole purpose of storing data, or be constructed as a part of an apparatus 20 serving other purposes, such as processing data.

A skilled person appreciates that in addition to the elements shown in FIG. 2, the apparatus 20 may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the apparatus 20 may comprise a disposable or rechargeable battery (not shown) for powering the apparatus 20 when external power if external power supply is not available.

Further, it is noted that only one apparatus is shown in FIG. 2, but the embodiments of the invention may equally be implemented in a cluster of shown apparatuses.

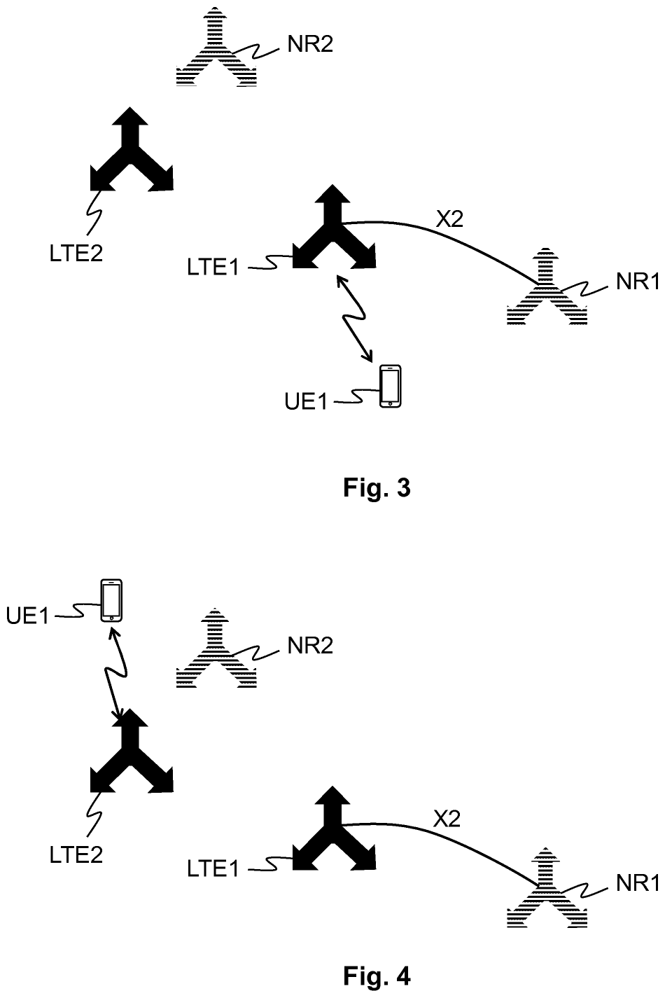

FIGS. 3-5 more closely show the concept of neighbor relations and a way of defining neighbor relations in a communication network, such as in the communication network 111, in accordance with certain embodiments. The communication network comprises cells of two different network generations. Herein the cells LTE1 and LTE2 are cells of the fourth generation 4G (LTE, Long Term Evolution) mobile communication network, and the cells NR1 and NR2 are cells of the fifth generation 5G (NR, New Radio) mobile communication network.

The 5G network, in this embodiment, runs in a non-standalone (NSA) mode. Accordingly, the user equipment (or mobile terminal) UE1 cannot use services of the cells of the 5G network (NR cells) alone without being connected to an LTE cell. An NR cell is connected to an LTE cell with a linking mechanism called a relational object. A relational object between an NR cell and an LTE cell can be setup for example by an X2 neighbor setup procedure.

In FIG. 3 it has been shown that the NR cell NR1 is connected to the LTE cell LTE1 by a relational object. Accordingly, the user equipment UE1 when being connected to the LTE cell LTE1 can use the services of the NR cell NR1.

FIG. 4 shows a situation in which a handover from one LTE cell (here: LTE1) to another LTE cell (LTE2) has been occurred. The UE1 might wish to use services of an NR cell NR2. However, in this case there is no relational object connecting the cells LTE2 and NR2.

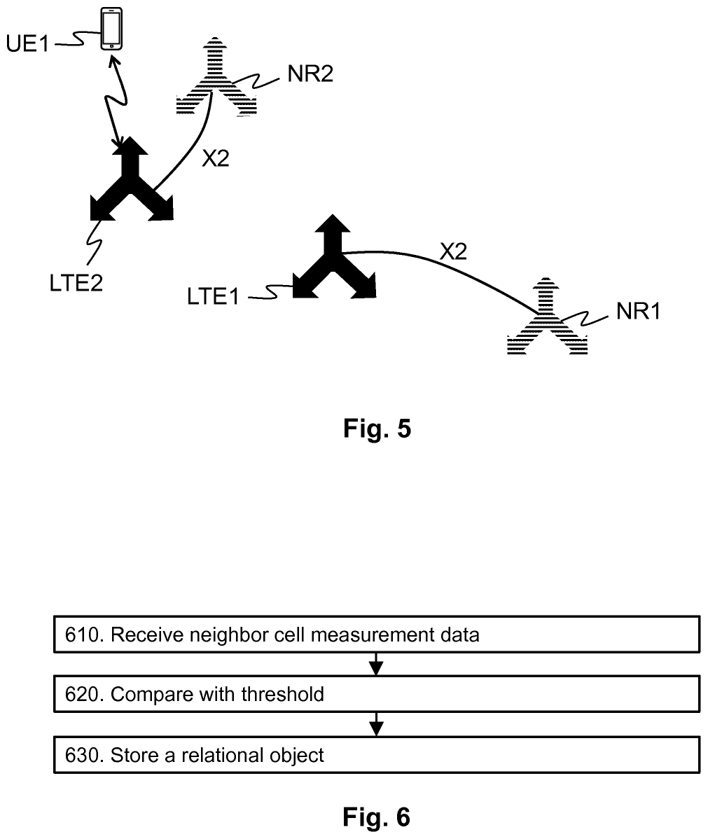

FIG. 5 shows a situation in which there is a relational object connecting the cells LTE2 and NR2. In this case, when the handover occurs between the cells LTE1 and LTE2, the UE1 can change from the cell NR1 to the cell NR2. Accordingly, the NR cell change is succeeded.

FIG. 6 shows a flow chart according to an example embodiment in which measurements are used to create relational objects. In phase 610 neighbor cell measurement data is received by an apparatus of a communication network from mobile user equipment(s) UE. In certain embodiments, the measurement data comprises data regarding inter-radio access technology, inter-RAT, handover. The neighbor cell or cells in this example may be NR cell(s) and the cell currently serving the UE in question may be an LTE cell. In certain embodiments, said measurement data indicates power of a signal received from the neighbor cell(s). In certain embodiments, the measurement data is received in the form of an event B1 measurement report.

In phase 620, the apparatus compares the received measurement data with a threshold, and phase 630 the apparatus stores a relational object connecting the serving cell and the neighbor cell based on said comparison.

In certain embodiments, said relational object is stored in the event the power exceeds the threshold. In certain embodiments, said storing comprises storing an identifier of the neighbor cell (into data or control data of the serving cell maintained by the apparatus).

In certain embodiments, the relational object is stored into a network element or into a memory accessible by the network element that controls inter-RAT handovers of mobile user equipments in the communication network(s).

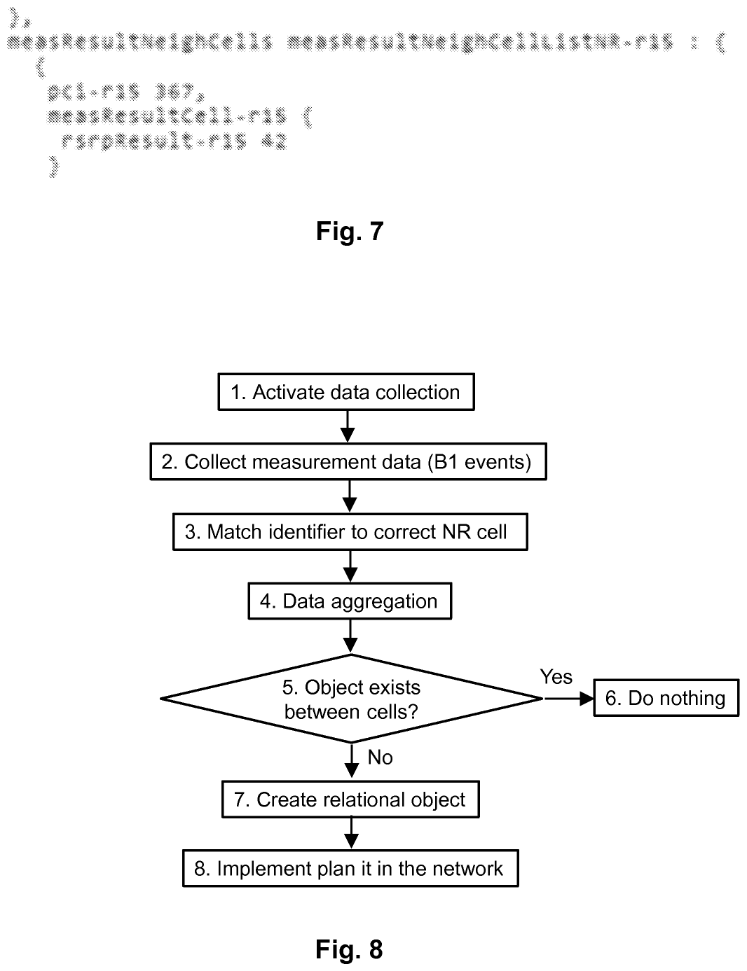

FIG. 7 illustrates an example of an event B1 measurement report according to an embodiment. In this embodiment, the threshold is set to −115 dBm. A measurement result “42” means that the UE in question received a signal power −114 dBm (in this context the value “42” refers to a difference from a reference power level −156 dBm so that the resulting power value is −156 dBm+42 dBm=−114 dBm) from the inter-RAT neighbor (NR cell) in question. The measured value exceeds the threshold. Accordingly, a relational object between the serving LTE cell and the NR cell corresponding to the reported identifier (PCI, physical cell identifier) is stored.

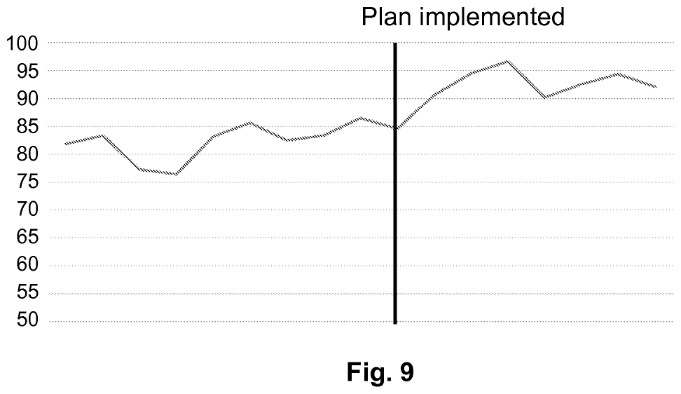

FIG. 8 shows a flow chart of a more detailed embodiment. In phase 1, data collection is activated. This may be done for example based on performance data, such as NR cell change success rate. In phase 2, measurement data based on B1 events is collected from UEs. In phase 3, if required, a received PCI is matched to a correct NR cell. Since the PCIs of the NR cells may be reused within the 5G network, for example coordinate data or antenna information may be used to map the PCI and the related measurements data to the closest NR cell. In phase 4, the received data is aggregated, for example at a cell pair level. In phase 5, it is determined whether a relational object exists between the cells in question. If “yes”, nothing needs to be done (phase 6). If “no”, the relational object is created and stored (phase 7), and a changed plan (e.g., XML) is implemented within the network in phase 8. FIG. 9 shows the NR cell success rate in percentages (when the LTE cell is changed) before and after implementing the plan.

Without limiting the scope and interpretation of the patent claims, certain technical effects of one or more of the example embodiments disclosed herein are listed in the following. A technical effect is providing a measurement-based method for managing automatic neighbor relations. Another technical effect is aiding in defining relational objects between different RAT cells. Another technical effect is an improvement in the 5G cell change success rate in the event the UE is handed over from one LTE cell to another LTE cell.

Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for defining neighbor relations in a communication network (110), the method comprising:
receiving (610) neighbor cell measurement data from a mobile user equipment, wherein said neighbor cell is of another radio access technology compared to the radio access technology of the current cell serving said mobile user equipment;
comparing (620) the received measurement data with a threshold; and
storing (630) a relational object connecting said serving cell and said neighbor cell based on said comparison.

2. The method of claim 1, wherein said measurement data indicates power of a signal received from the neighbor cell.

3. The method of claim 2, wherein said relational object is stored in the event the power exceeds the threshold.

4. The method of claim 1, wherein the serving cell is a cell of the fourth generation mobile network, LTE cell, and the neighbor cell is a cell of the fifth generation mobile network, NR cell.

5. The method of claim 1, wherein said receiving neighbor cell measurement data comprises receiving measurement data regarding inter-radio access technology, inter-RAT, handover.

6. The method of claim 1, wherein said receiving neighbor cell measurement data comprises receiving an event B1 measurement report.

7. The method of claim 1, wherein said storing a relational object comprises storing an identifier of the neighbor cell.

8. An apparatus (20, 111), comprising:
a processor (21); and
a memory (22) including computer program code (27), the memory (22) and the computer program code (27) being configured, with the processor (21), to cause the apparatus (20, 111) to perform the method of claim 1.

9. A computer program comprising computer executable program code (27) which when executed by a processor (21) causes an apparatus (20) to perform the method of claim 1.

10. The method of claim 2, wherein the serving cell is a cell of the fourth generation mobile network, LTE cell, and the neighbor cell is a cell of the fifth generation mobile network, NR cell.

11. The method of claim 3, wherein the serving cell is a cell of the fourth generation mobile network, LTE cell, and the neighbor cell is a cell of the fifth generation mobile network, NR cell.

12. The method of claim 2, wherein said receiving neighbor cell measurement data comprises receiving measurement data regarding inter-radio access technology, inter-RAT, handover.

13. The method of claim 3, wherein said receiving neighbor cell measurement data comprises receiving measurement data regarding inter-radio access technology, inter-RAT, handover.

14. The method of claim 4, wherein said receiving neighbor cell measurement data comprises receiving measurement data regarding inter-radio access technology, inter-RAT, handover.

15. The method of claim 2, wherein said receiving neighbor cell measurement data comprises receiving an event B1 measurement report.

16. The method of claim 3, wherein said receiving neighbor cell measurement data comprises receiving an event B1 measurement report.

17. The method of claim 4, wherein said receiving neighbor cell measurement data comprises receiving an event B1 measurement report.

18. The method of claim 5, wherein said receiving neighbor cell measurement data comprises receiving an event B1 measurement report.

19. The method of claim 2, wherein said storing a relational object comprises storing an identifier of the neighbor cell.

20. The method of claim 3, wherein said storing a relational object comprises storing an identifier of the neighbor cell.
